(19) United States
(12) Patent Application Publication
(10) Pub. No.: US 2004/0035008 A1
(43) Pub. Date: Feb. 26, 2004

(54) Bagel scooper

(76) Inventors: Elizabeth Chelsea Teich, Melville, NY (US); Meghan Joy Musgnug, Huntington Station, NY (US)

Correspondence Address: ALFRED M. WALKER, 225 OLD COUNTRY ROAD, MELVILLE, NY, 11747-2712, US

(21) Appl. No.: 10/644,470

(22) Filed: Aug. 20, 2003

Related U.S. Application Data
(60) Provisional application No. 60/404,842, filed on Aug. 21, 2002.

(51) Int. Cl. A47J 43/28

(52) U.S. Cl. 30/324; 30/147; 99/538

(57) ABSTRACT

A bagel scoop removes excess dough from a piece of baked goods, such as a bagel. The bagel scoop includes a handle, and a concave, preferably shallow elliptical spoon-shaped closed combined blade and scoop structure, having a downward curvature, to enable scooping and removal of dough. The outer distal end of the combined blade and scoop structure is preferably serrated, to allow for scraping and scooping of the bagel core dough at a leading edge of the blade. The combined blade and scoop structure is attached to a stem, which, in turn, is attached to the handle. A small auxiliary scraper is provided at an opposite end, for fine scraping and removing of excess dough residue not taken by the shallow elliptical spoon-shaped closed combined blade and scoop structure.

### FIELD OF THE INVENTION

The present invention relates to a device for scooping and removing excess dough from the inside of sliced bagels.

### BACKGROUND OF THE INVENTION

The present invention relates to a device for removing excess portions of the interior the dough from food products, such as bagels, which have been cut in half. The ability to scoop out the excess dough from the interior of a bagel can greatly decrease the number of calories and carbohydrates in a bagel. Also, the ability to scoop out a bagel while using a manually operable tool device, instead of with one's fingers, provides a more sanitary method of removal than using one's fingers.

Among related patent include U.S. Pat. No. 5,920,991 of Tracy, which discloses a device for cutting and loosening dough from a piece of baked goods, such as a bagel, which includes a handle, and an open blade structure, to enable scooping and removal of dough. The blade structure of Tracy '991 is attached to a cross bar, which is attached to a stem, which, in turn, is attached to the handle. There are five different parts to this structure (a blade, crossbar, stem, handle and set screw).

However, as noted in the drawing Figures of Tracy '991, Tracy is not capable of scooping and removing cut dough, since the dough cut by an open blade structure having a peripheral cutting edge adjacent to an open recess between the blade cutting edge and stem attaching the blade to the handle. For example, as shown in FIGS. 1 and 2 of Tracy '991, the cut dough excised by curved blade 14 falls through the open semi-circular recess hole provided between the cutting edge 22 of semi-circular blade 14 and the horizontal cross bar 32. Tracy '991 requires the additional step of manually removing the pieces of cut dough from the bagel, which defeats the purpose of providing a tool for cutting excess dough from the interior of a sliced bread product, such as a bagel.

Other food scraping articles having an open blade with a cutting edge defining a recess through which food passes include U.S. Pat. No. 4,345,516 of Sinclair for cooking an egg, U.S. Pat. No. 2,447,301 of Wright for a corn niblet scraper and U.S. Pat. No. 1,991,267 of Waldron for a bean pod cutter.

Among other related patents include U.S. Pat. No. 4,979,419 of Sonkin, which discloses a bagel cutter with a manually rotatable blade housing, having a pair of blades which scrape and cut excess bagel dough from the core of a sliced bagel. Like Tracy '991, Sonkin '419 cuts the core of the bagel but doesn't provide the ability to scoop out the core dough of the bagel, which still leaves that task to be done by the fingers of the user, which can be unsanitary.

Other rotating food scraping machines are described in U.S. Pat. No. 5,557,998 of Schwartz, for a rotating bagel coring device and U.S. Pat. No. 5,033,193 of Valenti, for a rotating bagel scooper.

Both Tracy '991 and Sonkin '419 require the use of another second device, to remove the unused dough scraped within the core of the bagel. Therefore, the present invention provides the utility of both the scooping and removing actions required.

Therefore, neither Tracy '991 nor Sonkin '419 describe a hand held bagel scooper for both scooping and removing excess dough from the inside of a bread product, such as a cut bagel.

Other related prior art patents include U.S. Pat. No. 644,732 of Crandall, which describes a corn cutting spoon, including a bottom mid portion of the concave spoon head being interrupted by a serrated cutting edge, which allows the user to scrape corn niblets loose from a corn cob, by a rearward pulling motion. However, the cutting edge of Crandall '732 is located away from the leading edge, since the exterior of a corn cob is tubular, with no concave recess within which to manipulate the tool.

Other spoon-shaped articles having a medial cutting edge at a recess thereof include U.S. Pat. No. 3,937,850 of Farba.

However, the aforementioned reference actually do not teach the use of a bagel scooper which both scrapes and removes bagel dough from the inner core of a sliced bagel.

The bagel scooper of the present invention overcomes the problems associated with the prior art references, such as the inability to remove the scraped dough material from a hollowed out bagel. Therefore, the prior art patents are unsatisfactory, because they do not have the means for both scraping and removing the excess bagel dough. The configurations of the cutting edges of the prior art, as well as the rotatable devices, hinder the effectiveness of scraping and removing excess bagel dough with further manual manipulation of the scraped bagel dough.

Thus, the aforementioned references teach devices which in general are not suitable for both scraping and removing excess bagel dough from the interior core of a sliced bagel or other food product.

The use of the concave scoop with a downward curvature and a combined blade and scoop at the leading edge of the concave member, as disclosed in the bagel scooper of the present invention, would be discouraged, if not clearly taught away from the prior art.

Therefore, the bagel scooper of the present invention is not only not suggested, but would be discouraged or taught away by the references relied on.

### OBJECTS OF THE INVENTION

It is therefore an object of the present invention to provide a hand held bagel scooper for both scooping and removing excess dough from the inside of a bread product, such as a cut bagel.

It is also an object of the present invention to provide bagel scooper which is sanitary and which eliminates scooping of excess dough from a bagel by the fingers of a user.

It is also an object of the present invention to provide a dough remover which is ergonomic and easy to use.

Other objects which become apparent from the following description of the present invention.

### SUMMARY OF THE INVENTION

In keeping with these objects and others which may become apparent, the present invention is device for removing dough from a piece of baked goods which includes a handle, and a concave, preferably shallow elliptical spoon-shaped combined blade and scoop structure, having a downward curvature, to enable scooping and removal of dough. The outer distal end of the combined blade and scoop structure is preferably serrated, to allow for scraping and scooping of the bagel core dough at a leading edge of the combined blade and scoop. The combined blade and scoop structure is attached to a stem, which, in turn, is attached to the handle.

The present invention is a device, which has three functions. Its structure is very simple, but practical. It is one long piece of stainless steel with a deep round hollow head used to make one big scoop to get all the dough out. At the other end is an optional small rectangular edge, embodied with teeth to further scoop the bagel providing a clean hollow bagel.

The two edges are connected by a handle preferably with a soft piece of rubber allowing for a safe grip, as well as a comfortable grip.

The present invention is a bagel scooper which unlike other food scrapers, actually scoops out the excess dough, leaving hardly, if any, excess dough residue. Alternatively, the bagel scooper of the present invention can be used to scrape other food products, such as bread rolls, vegetables or fruit.

Other inventions similar to the bagel scooper simply cut and flatten the dough, taking only the top layers of dough off. In contrast to the prior art, the bagel scooper of the present invention includes a deep concave head, which enhances the performance by enabling a person to scoop out and lift away the entire core of the bagel, thereby providing a much healthier meal.

For example, in contrast to the bagel scoop of the present invention, the bagel scraper of Tracy '991 is a general purpose device for use on baked goods in general. The single piece construction of the present invention simplifies the manufacturing process of fabricating the bagel scooper and it also enhances the reliability over Tracy '991 which has five different parts that are subject to breakage. Also, Tracy '991 has a weak structure point in the stem, connecting the blade to the handle, which is subject to break from the force of pressing down on the handle. In contrast to Tracy '991, the bagel scooper of the present invention is an improved design forged out of one piece of metal and therefore, not subject to possible failures of the multiple elements of the structure of the Tracy '991 design.

Unlike the corn cutting spoon of Crandall '732, which does not have a cutting edge at a leading edge, in the bagel scooper of the present invention the cutting surface is at a distal leading edge, to allow hand-held manipulation of the bagel scooper within the hollow, indented core of half toroidal shape of a cut bagel.

The bagel scoop of the present invention also is much more sanitary when used in a business such as a bagel store. The use of this handy tool provides the bagel store worker with a convenient way of pleasing the customer, as well as a safe way to scoop out the bagels, which are usually hot.

Another feature of the bagel scooper is its rear edge located at the opposite end of the actual scoop. This rear edge has preferably a small serrated edge, which can fine tune the extraction of excess dough from the inner core of the sliced bagel, picking up any left over dough from the original scoop. This just further ensures the cleanliness of the scoop, thus providing the customer or homeowner with a perfectly hollow bagel.

There are advantages to this style of preparing a bagel. First of all, carbohydrates are a big factor in keeping fit nowadays. By scooping the inner dough out, the bagel becomes significantly healthier. Also, by having a hollow core, the bagel scooper allows for food to be placed in the remaining pockets, almost similar to a pita shell. For example, one could place an egg white in the core and have a healthy egg breakfast, or try some hummus for a great snack.

Another feature of the bagel scooper is its elastomeric grip, made of a smooth cushion type material, such as rubber or foam. The elastomeric grip not only provides the user with a safe grip but it also allows for a comfortable grip.

The first and most important function of the present invention is to actually scoop the dough out of a bagel that has been cut in half. By doing so makes the bagel much healthier because the dough contains calories and carbohydrates which, in turn, will be removed.

The second function of the bagel scooper is its attraction to bagel stores and homeowners. By using this tool one can safely remove the dough without using their fingers. By using one's fingers, a user could get burnt, because bagels are sometimes hot and also it is unsanitary, especially in a business. Although most workers wear gloves, most workers also hand back money with those very gloves on. Then the workers use those gloves to pick out the dough, thus contaminating the bagel with germs or other pathogens transferred from the currency to the gloves of the fingers of the worker.

By using this hand held scoop of the present invention, the worker is happy because the worker is not getting burnt and more importantly, the customer is happy, which is always the main objective.

An advantage to this tool is also its attraction to homeowners. It is small and easily stored. Most homeowners buy bagels by the dozen. By having this bagel scooper at home, one could scoop out their own bagels making it a healthier snack, as well as providing a hollow pocket which is also a function of the bagel scoop of the present invention.

The bagel scooper not only picks out dough but by doing so creates hollow pockets allowing one to put food inside, much like a pita shell. This creates a convenient way to make a bagel sandwich.

The present invention greatly simplifies the structure of a bagel scooper since it is a one piece construction made out of a stiff, shaped stainless steel or other suitable material, which has a serrated spoon shaped cutting edge which is designed specifically for digging in and removing dough from bagels.

### BRIEF DESCRIPTION OF THE DRAWINGS

The present invention can best be understood in connection with the accompanying drawings. It is noted that the invention is not limited to the precise embodiments shown in drawings, in which:

FIG. 1 is a perspective view of the bagel scoop of the present invention;

FIG. 2 is the side view thereof;

FIG. 3 is the environmental view, showing how the bagel scoop of the present invention is capable of thoroughly scooping out the undesired part of the bagel;

FIG. 4 is the front view of the present invention, showing the teeth of the leading edge of the scooper, as well as the rear edge used for finer scooping; and,

FIG. 5 is another environmental view of the present invention displaying how the scooper fits comfortably in one's hand while being used.

### DETAILED DESCRIPTION OF THE INVENTION

The present invention has broad applications to many technical fields for a variety of food articles to have excess material scraped and removed without the need for further manual manipulation.

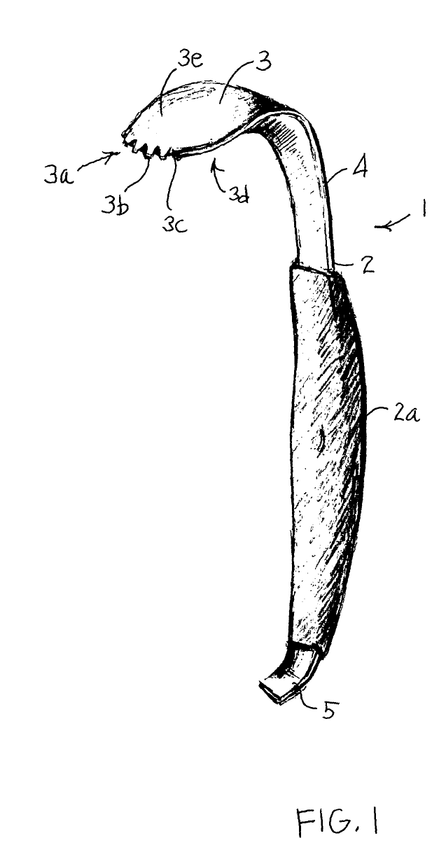

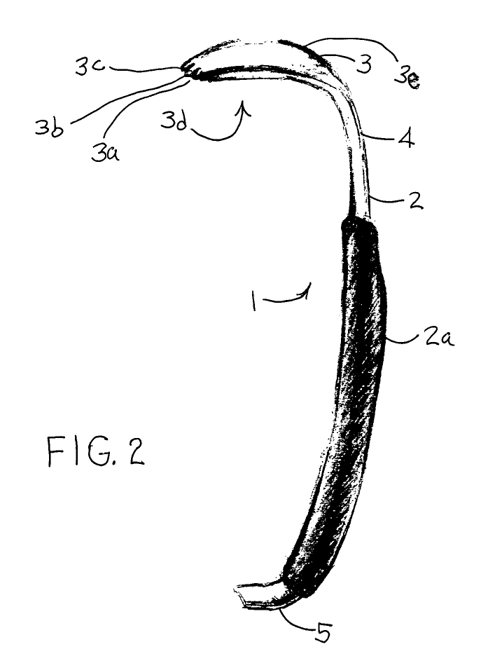

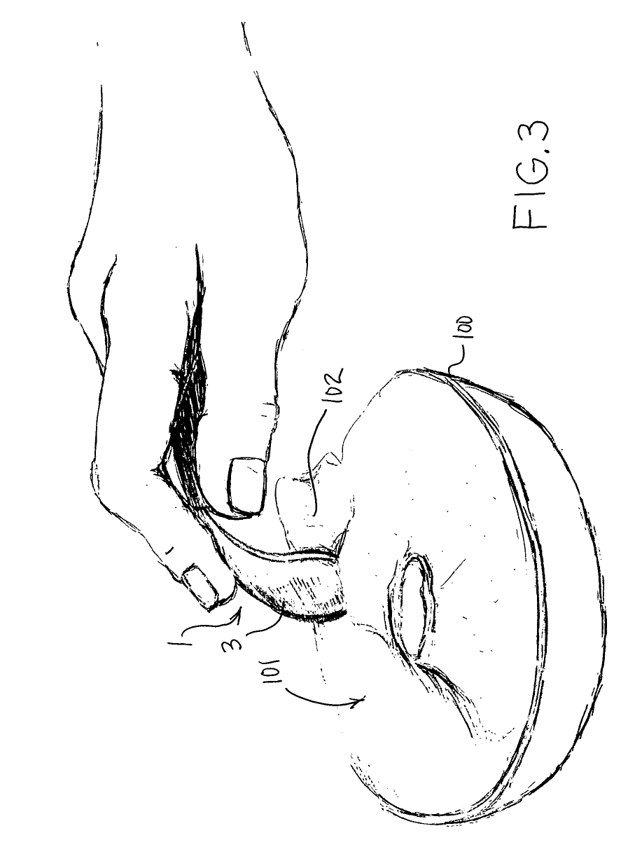

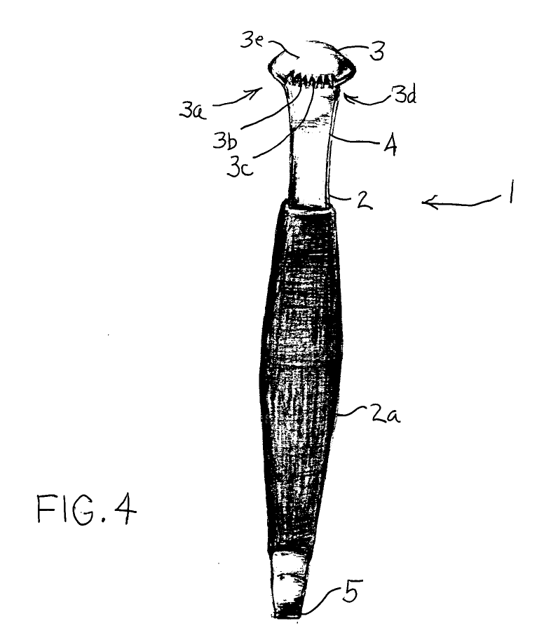

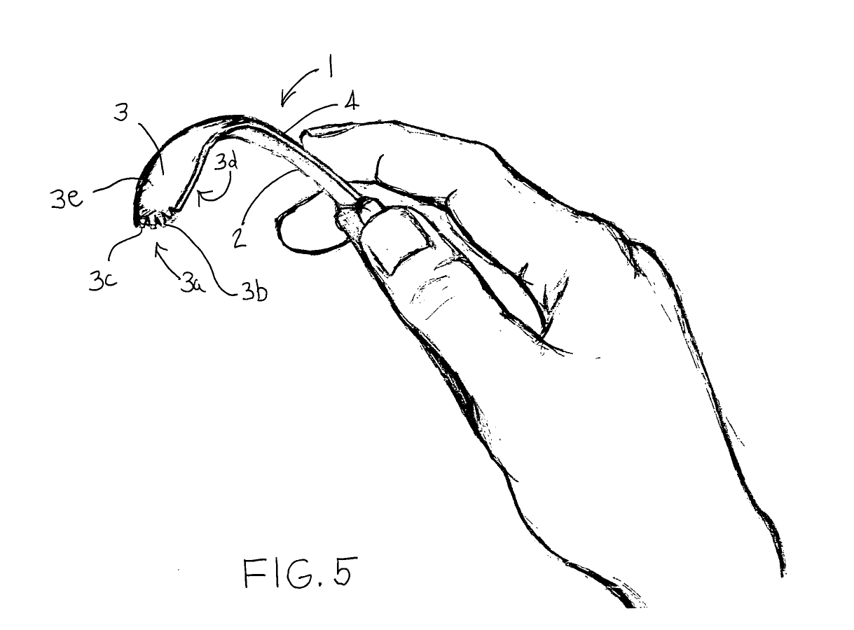

As shown in FIGS. 1-5, the bagel scoop 1 removes excess dough from a piece of baked goods, such as a sliced bagel. The bagel scoop 1 includes handle 2, and a closed concave combined blade and scoop structure 3, preferably being shallow and elliptical spoon-shaped, when viewed from above and in cross section, having a downward curvature extending forward and then downward off of the longitudinal axis of handle 2, to enable scooping and removal of excess dough 102 from inner bagel core 101 of bagel 100.

Outer distal end 3a of combined blade and scoop structure 3 is preferably serrated with teeth 3b, thus forming cutting edge 3c, to allow for scraping and scooping of bagel core dough 102 at leading edge 3c of combined blade and scoop structure 3. Blade structure 3 is attached to stem 4, which, in turn, is attached to handle 2.

Handle 2 of bagel scoop 1 is preferably is one long piece of stainless steel.

Combined blade and scoop structure 3 is preferably concave, having a closed recess 3d formed by closed bowl shaped wall 3e, forming a round hollow head container used to both scrape and remove excess dough 102 from inner core 101 of bagel 100.

At the other end of bagel scoop 1 is an optional small scraper 5, preferably being of a rectangular edge, embodied with teeth to further scoop the bagel 100, with a clean hollow bagel core 101. Small scraper 5 also has a downward curvature off of the longitudinal axis of handle 2, to both scrape and remove fine pieces of dough residue not removed by combined blade and scoop structure 3 at the other leading end of bagel scoop 1.

Small scraper 5 also functions as an ergonomic rest for the lateral edge of the palm of the fist of the user holding handle 2 of bagel scoop 1.

Combined blade and scoop structure 3 and small scraper 5 are connected by handle 2, preferably with a soft cushion sleeve 2a, such as a hollow piece of rubber, allowing for a safe grip, as well as a comfortable grip.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

We claim:

1. A manually held scoop removing excess dough from a piece of a food product goods comprising:
a longitudinally extending handle, having a concave closed combined blade and scoop structure at a distal end thereof,
said concave closed combined blade and scoop structure having a downward curvature,
said shallow elliptical spoon-shaped closed combined blade and scoop structure scooping and removing excess residue from an inner core of the food product.

2. The manually held scoop as in claim 1 wherein an outer distal end of said concave combined blade and scoop structure is serrated with teeth scraping and scooping of the food product residue, said teeth being located a leading edge of said concave closed combined blade and scoop structure.

3. The manually held scoop as in claim 1 further comprising an auxiliary scraper being provided at an opposite end of said bagel scoop.

4. The manually held scoop as in claim 1 wherein said closed concave combined blade and scoop structure is shallow elliptical spoon-shaped.

5. The manually held scoop as in claim 1 wherein said closed concave combined blade and scoop structure extends in a downward curvature from a longitudinally extending axis of said handle.

6. The manually held scoop as in claim 3 wherein said auxiliary scraper provides a resting area for the lateral portion of the user's palm when operating said manually held bagel scoop.

7. The manually held scoop as in claim 1 wherein the food product is a sliced toroidal baked bagel.

8. A manually held bagel scoop removing excess dough from a sliced toroidal bagel food product comprising:
a longitudinally extending handle, having a concave shallow elliptical spoon-shaped closed combined blade and scoop structure at a distal end thereof, said concave shallow elliptical spoon-shaped closed combined blade and scoop structure;
said closed concave combined blade and scoop structure extending in a downward curvature from a longitudinally extending axis of said handle;
said concave shallow elliptical spoon-shaped closed combined blade and scoop structure scooping and removing excess residue from an inner core of the bagel food product;
an outer distal end of said concave combined blade and scoop structure being serrated with teeth, said teeth scraping and scooping the bagel food product residue, said teeth being located a leading edge of said concave shallow elliptical spoon-shaped closed combined blade and scoop structure; and,
an auxiliary scraper being provided at an opposite end of said bagel scoop; said auxiliary scraper provides a resting area for the lateral portion of the user's palm when operating said manually held bagel scoop.
